(19) United States
(12) Patent Application Publication
(10) Pub. No.: US 2015/0131406 A1
(43) Pub. Date: May 14, 2015

(54) APPARATUS AND METHOD FOR ENTRAINING A POWDER IN A FLUID

(71) Applicant: Pursuit Marine Drive Limited, Little Chesterford (GB)

(72) Inventors: Robert Scott, Godmanchester (GB); Jens Thorup, Bury (GB); Sabina Burmester, Cambridge (GB); Matthew Dyer, Islip (GB); Damien Cosgrove, Bury (GB); Michelle Gothard, Royston (GB); Martin Prescott, Godmanchester (GB); Ross Vinten, South Bretton (GB)

(21) Appl. No.: 14/395,439

(22) PCT Filed: Apr. 19, 2013
(86) PCT No.: PCT/GB2013/051002

§ 371 Date: Oct. 17, 2014

(30) Foreign Application Priority Data
Apr. 19, 2012 (GB) 1206912.6

(51) Int. Cl. B01F 5/04; B01F 15/02; B01F 3/12

(52) U.S. Cl. CPC B01F 5/0413; B01F 3/12; B01F 15/026; B01F 2005/0438
USPC 366/151.1; 366/163.2

(57) ABSTRACT

An apparatus for entraining a powder in a process fluid is provided. The apparatus (2′) has a process passage (22) having a passage inlet (24) connectable to a source of process fluid, and a passage outlet (26). A nozzle (30) opens into the process passage (22) intermediate the passage inlet (24) and passage outlet (26). The nozzle (30) has a nozzle inlet (32), a nozzle outlet (36) and a nozzle throat (34) intermediate the nozzle inlet (32) and nozzle outlet (36), where the nozzle throat (34) has a cross sectional area which is less than that of the nozzle inlet (32) and nozzle outlet (36). At least one first port (42′) opens into the process passage (22) adjacent the nozzle outlet (36), and an entrainment fluid supply chamber (38) is in fluid communication with the nozzle 30. A first powder supply chamber (44′) is connected to the first port (42′) by a first powder supply passage (46), wherein the powder supply chamber (44′), powder supply passage (46) and first port (42′) are coaxial. A system and method of entraining a powder in a process fluid are also provided.

The present invention is concerned with the entrainment and mixing of a powder into a process fluid.

A large number of commercial products, such as foods (e.g. low fat spreads, ice creams, re-constituted milk, sauces and dressings), personal care products (e.g. face, body creams and toothpaste, the former containing elastomers and the latter silica based powders and gelling polymers), pharmaceutical products (e.g. anti-acids containing high volume percentage of clay minerals), paints (e.g. with high content of pigments), coatings and pesticide products, are dependent on the formation of structured materials. A known method of forming such structured materials is the entrainment of one or more powders in a process fluid and the efficient mixing of the same, i.e. increase the interfacial area between the powder and the fluid to ensure dispersion, dissolution and/or hydration, and meet the specific requirements of the end product such as homogeneity, appearance, stability and functionality.

Such commercial processes require relatively long operation times and simple and quick cleaning and/or maintenance procedures to minimise and/or eliminate process downtime.

Known powder entrainment methods include pumping a process fluid into an apparatus and introducing a powder by using Venturi effects or mechanical means to achieve good dispersion of the powder into the process fluid. In these methods, the process fluid is forced through narrow apertures which can lead to non-homogeneous shear fields and stagnant areas. Moreover, a number of problems exist with the current technologies:
where the process involves multi-phase materials, segregation of the individual components can occur which results in a non-consistent product quality due to the materials experiencing different residence times;
when processing high value and shear sensitive materials, damage to the same can result due to the long residence times the materials are exposed to;
when the fluid has a low water content, the entrainment of powder into the fluid is hindered;
where compressed gas is used as the motive medium, product aeration can be problematic. In some cases de-aerators are required to remove the entrained air.

Furthermore, when mechanical means are used to increase the interfacial area between the powder and the fluid, and in presence of abrasive materials, significant wear can take place due to the close contact of the particles with the surfaces of the mechanical components of the processing apparatus.

Powder may be fed into a supply passage communicating with an inlet port of a process passage. However, the supply passage and inlet port are susceptible to blocking. Furthermore, the powder is wetted prior to entering the process passage where it is entrained with a process fluid flowing through the process passage. Undesirably, compaction of the powder at the inlet port can occur resulting in inefficient flow rates, undesirable blockages and apparatus downtime. A relatively high flow rate of powder into the process passage is desirable for increased powder addition, dispersion and homogeneity. Furthermore, wetting of the powder upstream of the inlet port can cause gel beads to form where the powder is a gelling polymer, for example.

A further problem exists with the wetting of surfaces within known apparatus, particularly in the vicinity of the powder inlet port. Lipping of the process fluid has been found to occur in the process passage in the vicinity of the powder inlet port which presents an undesirable wet surface for powder on restarting an entrainment process, for example. When powder is reintroduced, it is immediately wetted due to the relatively low velocity region in the vicinity of the inlet port which can cause lumps or beads to form, which would adversely affect the quality of the entrained product and/or cause blockages to occur within the apparatus. Furthermore, the whole process or just the powder feed typically requires stopping and starting and a dry environment on start-up is essential to prevent wetting of the powder prior to entrainment and the problems associated therewith. These problems are made worse where hygroscopic powders are being used. Therefore, known apparatus must be cleaned and dried prior to each process run to ensure a dry start which has an adverse effect on efficiency and cost.

Finally, powders typically include mineral-based powders which can be abrasive and undesirably cause wear to the apparatus due to the high shear forces being generated in the processing apparatus. As a result, known apparatus is only suitable for short batch operations and not long industrial process operations.

It is an aim of the present invention to obviate or mitigate one or more of the aforementioned disadvantages.

According to a first aspect of the invention there is provided an apparatus for entraining a powder in a process fluid, comprising:
a process passage having a passage inlet connectable to a source of process fluid, and a passage outlet;
a nozzle opening into the process passage intermediate the passage inlet and passage outlet, the nozzle having a nozzle inlet, a nozzle outlet and a nozzle throat intermediate the nozzle inlet and nozzle outlet, wherein the nozzle throat has a cross sectional area which is less than that of the nozzle inlet and nozzle outlet;
at least one first port opening into the process passage adjacent the nozzle outlet;
an entrainment fluid supply chamber in fluid communication with the nozzle; and
a first powder supply chamber connected to the first port by a first powder supply passage, wherein the powder supply chamber, powder supply passage and first port are coaxial.

The process fluid is typically in a liquid state and examples may include water, a sugar alcohol such as glycerol, a solvent such as ethanol, a sugar syrup such as glucose or fructose syrup, for example. The process fluid may also be a slurry of, for example, a thickening agent in water. Alternatively, the process fluid may be a mixture of liquids, an oil-in-water, a water-in-oil or an oil-in-water-in-oil emulsion, an aqueous or non-aqueous solution or suspension or dispersion of particles, or water containing one or more structuring components such as, for example, surfactants and/or thickening agents.

Suitable powders may include non-state changing powders, e.g. silica, pigments, clays, sugars, milk powders, zeolites, which simply dissolve into the fluid once entrained and mixed, state changing powders, e.g. Carboxymethylcelluloses, Xanthan, Carbopol, Carragenan, Alginates, which gel and/or swell once in contact with water, and shear sensitive materials, e.g. dry encapsulated materials, fragrances and enzymes.

Direct entrainment of the powder into the process passage has been found to increase the efficiency of hydrating the powder, in particular gelling polymers, without forming gel beads or lumps, whilst increasing the rate of entrainment, particularly for non-gelling powders. A direct flow path from the powder supply chamber to the first port, i.e. a path which does not significantly deviate from its destination and provides substantially the most direct path thereto for powder to flow freely under the influence of gravity, has also been found to help eliminate blockages and ensure the rate of powder addition to the entrainment process is unlimited and kept constant. The powder feed is preferably volumetrically regulated and may be fluidic, aerated or free-flowing.

The first port is located at a low pressure region of the process fluid in the process passage, where reduced wetting of the inlet port takes place with a minimum level of non-occluded air being entrained. The low pressure region advantageously draws the powder into the process passage from the first port and ensures the powder remains moving to prevent blockages. Suitably the low pressure region is provided by an immediate pressure reduction of the entrainment fluid when exiting the nozzle into the process passage. As it moves towards the passage outlet, the fluid will begin to decelerate resulting in an increase in pressure and rapid condensation of the vapour present in the entrained fluid/powder mix. The point at which this rapid condensation occurs defines a condensation shockwave within the process passage. The position of the shockwave within the process passage is determined by the supply parameters of the process fluid and powder, geometry of the apparatus and, where steam is used as the entrainment fluid, the dryness fraction of the steam.

The first port may be located downstream of the nozzle. Preferably the first port comprises a single aperture entering into the process passage. The single aperture may be provided in a wall of the process passage.

Preferably the powder supply passage has a uniform cross sectional area along its length. Preferably the powder supply passage is circular in cross section and has a uniform diameter along its length.

Preferably the powder supply chamber is circular in cross section. The powder supply chamber may correspond in cross sectional area and/or diameter to the powder supply passage. However preferably the powder supply chamber is tapered such that its cross sectional area gradually decreases in a direction of powder flow towards the powder supply passage.

The cross sectional area of the inlet port, powder supply passage and powder supply chamber is dependent on flow rate, flow characteristics (e.g. stickiness, free and non-free flowing) and state changing properties of the powders. Preferably the first port has a cross sectional area which is at least half the cross sectional area of the process passage. The first port may have a cross sectional area which is at least half that of the process passage, allowing a wide range of powders to flow freely from the powder supply chamber to the first port and any eddies or stagnant regions in the process passage in the vicinity of the first port to be at least minimised and preferably eliminated. The first port may have a cross sectional area which is substantially identical to that of the process passage. The flow properties of the powder may be improved by using air, or other suitable gas, to fluidise the powder in the powder supply chamber and/or powder supply passage. Alternatively or additionally, vibration or mechanical means, e.g. a scraper, may be used. Preferably the amount of gas used to fluidise the powder is controlled and minimised to reduce unwanted aeration of the final product.

Suitably a powder supply passage and/or powder supply chamber may be selected from a plurality of powder supply passages and/or powder supply chamber each having different cross sectional area for the specific flow characteristic of a powder. Additionally, there is preferably a powder delivery regulator upstream of the powder supply passage. The regulator may be a dosing device such as an auger feeder.

The cross sectional area of the first port, powder supply passage and powder supply chamber may be substantially the same. In other words, the cross sectional area of the powder supply passage and powder supply chamber may not change significantly along its length to the first port. Preferably the powder supply chamber tapers towards an upper end of the powder supply passage having a uniform cross section along its length and terminating at a lower end to provide the first port. In any case, their geometry should not allow generation of stagnant regions for powder to accumulate, thereby to ensure powder flow is constant and unimpeded to prevent blockages. Preferably the powder supply chamber and powder supply passage are adapted to minimise friction for the powder flow at the walls which may be achieved by using polished surfaces and/or low friction materials.

Preferably the powder supply chamber has one or more walls which are at an angle less than or equal to 45° relative to a longitudinal axis of the chamber. Typically, the longitudinal axis of the chamber is the vertical axis. Preferably the angle of the chamber wall(s) is below 30° and most preferably between 10° and 15°. The angle of the wall(s) may vary around the circumference of the chamber. The angle of the wall(s) may vary at various points longitudinally along the chamber.

Preferably the powder is supplied generally vertically and directly to the first port in a continuous direction relative to an axis of the process passage. This ensures the most direct path is taken by the powder to reduce the risk of blockages, particularly where non-free flowing and/or relatively dense powders are used. The angle of the powder supply passage relative to the process passage may be from ninety degrees (perpendicular) or zero (coaxial with the process passage). For the latter example, the powder supply chamber, powder supply passage and first port may be provided at the inlet of a vertically arranged process passage to be coaxial therewith and located either upstream or downstream of the nozzle. The process fluid may be supplied upstream or downstream of the first port at an angle, such as perpendicular, to the process passage. Suitably, at least the powder supply passage and first port may be surrounded by a collar to define a space around the same. The process fluid may be supplied into the space to flow around and along the outside of the powder supply passage to impinge on the powder exiting the first port. The entrainment fluid, such as steam, may be supplied upstream or downstream of the first port dependent on the residence time required for the entrainment fluid to penetrate into the process fluid and create a highly turbulent region to induce the mixing between the process fluid and the powder. The process fluid and powder may then be entrained by the entrainment fluid being injected into the process passage from the nozzle.

The apparatus may further comprise a valve to sealingly separate the powder supply passage from the process passage when in a closed position and communicate the powder supply passage with the process passage when in an open position, the valve being located proximal the first port to minimise wetting of the first port and powder supply passage and thereby powder flowing therethrough at start-up and shut-down operations.

Suitably the valve may be a first valve located at the first port and a second valve may be located upstream of the first valve to control the flow of powder towards the first port. The second valve may control the flow of powder into the powder supply chamber from a powder source, such as a hopper. The first valve may selectively control the rate of powder flowing through the powder supply passage to the first port and stop or start the flow of powder accordingly. The second valve may be a ball, butterfly or gate valve, for example.

In operation, the process fluid may be supplied to the inlet of the process passage to flow therethrough. The entrainment fluid, such as steam, may then be supplied to the process passage through the nozzle.

The powder supply chamber may comprise one or more through apertures adapted to allow air to pass into the chamber. Suitably the through apertures are equally spaced around the chamber and may be angled radially and/or tangentially relative to the longitudinal axis of the chamber to promote directed flow into the chamber. Furthermore the cross sectional area of the apertures may be constant, or may reduce from inlet to outlet so as to accelerate the flow of powder, or may increase from inlet to outlet so as to decelerate the powder as it enters the chamber. After the supply of entrainment fluid is opened, the air may be pumped or drawn into the chamber due to the pressure differential to provide an air curtain to prevent any process fluid and/or entrainment fluid from entering the first port and powder supply passage to ensure the same are dry at all times. An alternative way to prevent process fluid entering the first port from the process passage is by increasing the entrainment fluid pressure but this increases the temperature of the product which can be detrimental to the product quality.

In addition, the apertures in the powder supply chamber allow formation of an air curtain in the chamber to fluidise the powder. This ensures sticking or clogging of the powder in the chamber is prevented and the powder is kept moving when the valve is in the open position.

The first valve may then be selectively operated to an open position to allow powder to flow through the powder supply passage from the powder supply chamber to the first port and into the process passage to be entrained in the process fluid by the entrainment fluid. Providing the first valve proximal or at the first port prevents process fluid from entering the powder supply passage which would undesirably wet the walls of the same and cause lumps or beads to form in the powder when the same is supplied to the first port on start-up. This problem would otherwise be made worse where hygroscopic powders are being used.

Suitably the first valve may comprise an elongate valve member slideably mounted in a valve body. A second end of the valve member may be selectively driven by an actuator in an axial direction between open and closed valve positions. The actuator may be a solenoid, for example.

Preferably the valve body comprises a through aperture to form part of the process passage between the passage inlet and passage outlet. Preferably the valve body comprises the first port and the powder supply passage extending on a vertical plane from the process passage to an edge of the valve body to provide a side port in the valve body. Suitably the powder supply chamber may connect directly with the side port.

The powder supply passage is arranged vertically in the valve body to allow powder to flow under the influence of gravity from the powder supply chamber to the first port and into the process passage. The powder supply passage may be aligned on the same vertical plane as the process passage and the first valve may move along a horizontal valve bore extending into the powder supply passage to selectively open or close the same. The valve member may comprise a valve passage arranged perpendicularly to its axis which is adapted to align with the first port and powder supply passage when the valve is in an open position and to move out of alignment with the same when the valve is moved to a closed position. When aligned, powder may flow through the valve and into the process passage, whilst being prevented from flowing through the valve when in the closed position.

Alternatively the valve body may comprise a throughbore offset from but in close proximity to and communicating with the process passage which provides the powder supply passage at one end and a valve bore at the other end. The valve member may move from a closed position (shutting off the powder supply passage from the first port) to an open position in a direction away from the powder supply passage and chamber.

Suitably the valve member may comprise an integral valve head. Alternatively, the valve head may be separate and mounted to the valve member. The valve head may comprise a threaded bore corresponding to an external thread of the elongate valve member to receive a first end thereof.

Preferably the valve member forms a surface of the process passage when in the closed position. Preferably the valve member forms a continuous surface of the process passage when in the closed position. The valve provides a continuous process passage in at least the vicinity of the first port when in the closed position to eliminate the undesirable effects of turbulence and/or powder accumulation and/or lipping otherwise caused by discontinuities of the process passage, such as stepping or sudden changes in cross sectional area. The valve member may comprise a recess which aligns with the process passage when in the closed position to provide the continuous surface.

An alternative first valve arrangement may comprise a rotary valve instead of a piston valve. The rotary valve comprises a rotary valve member comprising a longitudinal throughbore which defines at least part of the powder supply passage, the throughbore being offset from the axis of rotation of the rotary valve. In an open position, the powder supply passage is aligned with the first port and the powder supply chamber to allow powder to pass therethrough and into the process passage. When rotated to a closed position, the powder supply passage is not aligned with the first port and powder supply chamber so powder is prevented from flowing to the process passage. Such an arrangement also provides a dry barrier when the valve is closed to prevent process fluid otherwise entering the first port and powder supply passage and causing undesirable wetting which poses significant problems on start-up and powder flows to the process passage, particularly for hygroscopic powders, as described above. The first valve may be rotated by an electric, hydraulic or pneumatic drive, for example, or be rotated manually by one or more levers coupled to the valve member.

Preferably the rotary valve member comprises the powder supply passage and the powder supply chamber. The rotary valve member may comprise an upper chamber portion forming an upper inlet of the valve member, and an offset lower chamber portion being arranged between the upper chamber portion and the powder supply passage, wherein the powder supply passage forms a lower outlet of the valve member. The upper inlet may be concentric with the valve member and the upper chamber may taper inwardly to the offset lower chamber portion. The lower chamber portion may taper inwardly to the powder supply passage. The lower chamber portion may be a symmetrical offset cone.

Further alternatively the first valve may comprise a ball valve having a central throughbore defining the powder supply passage. In an open position, the throughbore aligns with the powder supply chamber and first port to allow powder to flow therethrough, whilst when rotated into a closed position, the throughbore is out of alignment with the powder supply passage and first port. An exterior surface of the ball valve member may form part of the process passage wall when in the closed position to provide a dry barrier between the process passage and the powder supply passage to prevent ingress of process fluid therein and to ensure the powder supply passage is dry at all times. A lever may be provided to manually operate the ball valve or it may be adapted to be driven by an electric, hydraulic or pneumatic drive, for example.

An alternative arrangement for the apparatus is where the angle of the powder supply passage is zero relative to the process passage axis, i.e. is coaxial with the process passage. In this embodiment, the differential between the process fluid and the powder velocity is minimised which has been found to increase the rate of entrainment and reduce wetting of the inlet port. The inlet port may comprise a convergent portion to further prevent ingress of process fluid into the inlet port.

Preferably the powder supply chamber is connected to a powder source. The powder source may comprise a hopper connected directly to the powder supply chamber or indirectly via a powder feed conduit. The feed conduit may comprise the second valve. The feed conduit may comprise a dosing device, e.g. an auger, spiral or twin screws, to ensure constant powder flow rate from the powder source to the powder supply passage. The hopper may comprise a paddle or stirrer.

The inlet of the process passage may have a first cross sectional area, and the cross sectional area of the process passage does not reduce below the first cross sectional area at any point between the passage inlet and passage outlet. For high volume non-phase or state changing entrainment, a portion of the process passage may have an increased cross sectional area to define an entrainment chamber. Preferably the entrainment chamber is spaced from the nozzle. Preferably the entrainment chamber communicates with only a downstream portion of the first port.

The increased cross sectional area of the entrainment chamber downstream and spaced from the nozzle has a number of technical effects. Firstly, a region of low pressure is created downstream of the first port opening into the passage thereby to continuously draw powder into the process passage at a constant rate to accommodate for large powder entrainment rates and to prevent blockages. Secondly, the powder is drawn into the process passage in a downstream direction and away from the nozzle so any wet surfaces caused by lipping of fluid in the vicinity of the nozzle are avoided. Thirdly, the powder entering the process passage is spaced from the relatively hot nozzle and injected steam so local heating of the first port and powder is avoided. It has been found that such an arrangement achieves 22% w/w entrainment using a silica-based powder (density of 0.28 g/cm3), which is equivalent to ca. 50% vol/vol into 50 l/min of fluid with density of 1 g/cm3 and an entrainment vacuum of −0.7 barg is generated in the processing chamber. Furthermore, powder wetting, entrainment and hydration all could take place in the processing chamber at ultra-high speed from milliseconds (e.g. Carboxymethylcellulose) to a few minutes (e.g. Carbopol) depending on the hydration and swelling rate of the powder, low pressure phase, eliminating the need to wet the powder before entrainment which can undesirably lead to the formation of lumps and/or blockages. Alternatively, they could continue to take place up to a few minutes downstream of the processing chamber. The likelihood of formation of lumps depends on the ratio between the dispersion and the agglomeration rate of the powder when in presence of the process fluid, i.e. it depends on the wetting and diffusion of the process fluid into the powder, which can result in formation of strong networks between the powder and the process fluid.

The nozzle may have a nozzle inlet, a nozzle outlet and a nozzle throat portion intermediate the nozzle inlet and nozzle outlet, the throat portion having a cross sectional area which is less than that of either the nozzle inlet or nozzle outlet. The nozzle may comprise a plurality of nozzle outlets spaced around the process passage or may be an annular nozzle circumscribing the process passage.

The apparatus may further comprise an entrainment fluid supply passage upstream of the entrainment fluid supply chamber, wherein the nozzle inlet has a cross sectional area which is less than that of the entrainment fluid supply passage. The entrainment fluid supply chamber may be annular and located radially outward of the process passage.

The process passage may comprise a plurality of further ports placed in an annular and/or longitudinal arrangement in the process passage, each further port being connected to a corresponding powder supply passage and powder supply chamber.

The apparatus may further comprise at least a second port opening into the passage. The second port may be arranged annularly or longitudinally relative to the first port. The apparatus may further comprise a second powder supply chamber in communication with the second port. Alternatively, the second port may be in communication with the first powder supply chamber. The second port may open into the process passage downstream of the first port. Alternatively, the second port may open into the passage upstream of the nozzle. A first powder may be fed into the process passage from both the first and second ports or different powders may feed into each of the first and second ports. Such an arrangement may be desirable to entrain different powders into a process fluid either simultaneously or separately.

The apparatus may further comprise an air injection/purge arrangement for fluidising powder in the powder supply chamber and/or powder supply passage or for clearing powder in at least the powder supply chamber and/or powder supply passage. The air injection/purge arrangement may operate before or after a process run, or it may operate continuously including during a process run.

According to a second aspect of the invention, there is provided a system for entraining a powder in a process fluid, the system comprising:
at least one apparatus in accordance with the first aspect of the invention;
a process fluid supply vessel in fluid communication with the process passage inlet;
an entrainment fluid supply in fluid communication with the entrainment fluid supply chamber;
a first powder supply vessel in communication with the first powder supply chamber;
a plurality of control valves for controlling the supply of process fluid, entrainment fluid and powder to the apparatus;
a plurality of sensors located in at least the process passage of the apparatus; and
an electronic control unit adapted to selectively open and close the control valves in response to signals from the plurality of sensors.

The first powder supply vessel is suitably connected to the powder supply chamber by a powder supply conduit. The powder supply vessel is preferably provided generally vertically above the powder supply chamber. The powder supply conduit may include a ball valve for controlling powder flow from the powder supply vessel to the powder supply chamber. The powder supply conduit may further comprise a pump and/or auger, spiral or twin screws for feeding powder through the same towards the powder supply chamber.

The system may further comprise an air injection/purge arrangement for fluidising powder in the powder supply chamber and/or powder supply passage or for clearing powder in at least the powder supply chamber and/or powder supply passage. The air injection/purge arrangement may operate before or after a process run, or it may operate continuously including during a process run.

Suitably the powder supply vessel may be a hopper which may include a stirrer or paddle.

The system may comprise a plurality of apparatus according to the first aspect of the invention, wherein the apparatus are placed in series or parallel with one another. The supply chambers of each of the plurality of apparatus may be supplied with different powders or they may each be provided with a batch of the same powder.

According to a third aspect of the present invention there is provided a method of entraining a powder in a process fluid, the method comprising:
supplying a process fluid to a process passage having a passage inlet and a passage outlet;
supplying an entrainment fluid to a nozzle which opens into the process passage intermediate the passage inlet and passage outlet, the nozzle having a nozzle inlet, a nozzle outlet and a nozzle throat intermediate the nozzle inlet and nozzle outlet, wherein the nozzle throat has a cross sectional area which is less than that of the nozzle inlet and nozzle outlet;
supplying a powder from a first powder supply chamber via a first powder supply passage to a first port opening into the process passage adjacent the nozzle outlet, wherein the powder supply chamber, powder supply passage and first port are coaxial;
accelerating the entrainment fluid through the nozzle throat; and
injecting the entrainment fluid from the nozzle outlet into the process fluid and powder within the process passage.

Preferred embodiments of the present invention will now be described, by way of example only, with reference to the accompanying drawings, in which:

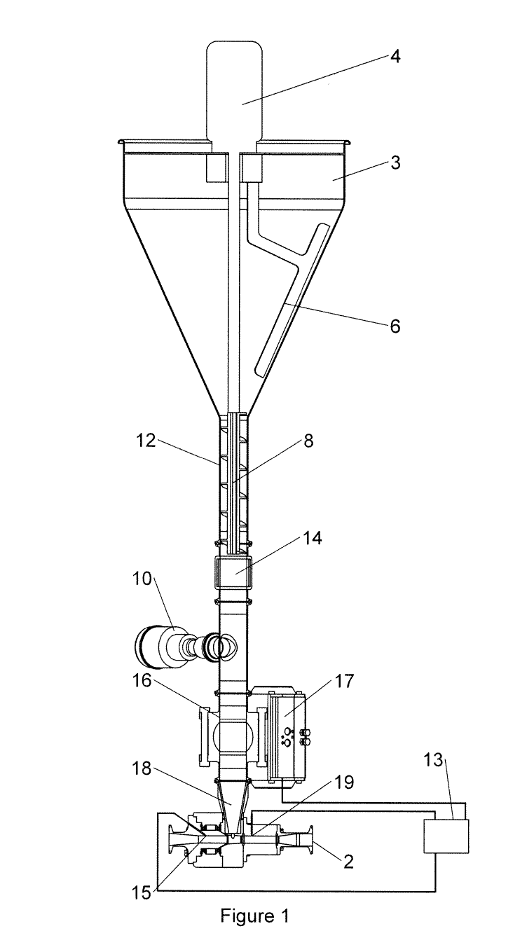

FIG. 1 shows a system for entraining powder in a process fluid;

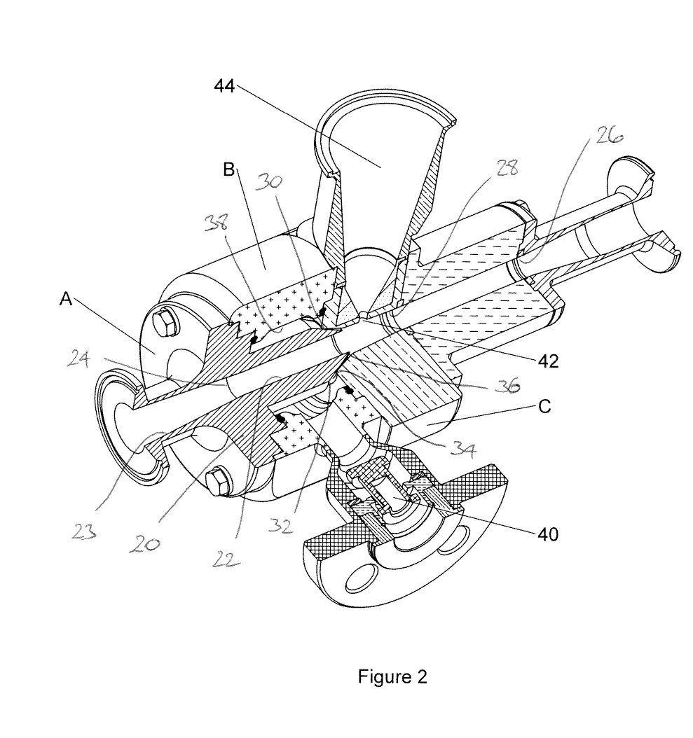

FIG. 2 shows an isometric cut out of an apparatus used in the system of FIG. 1;

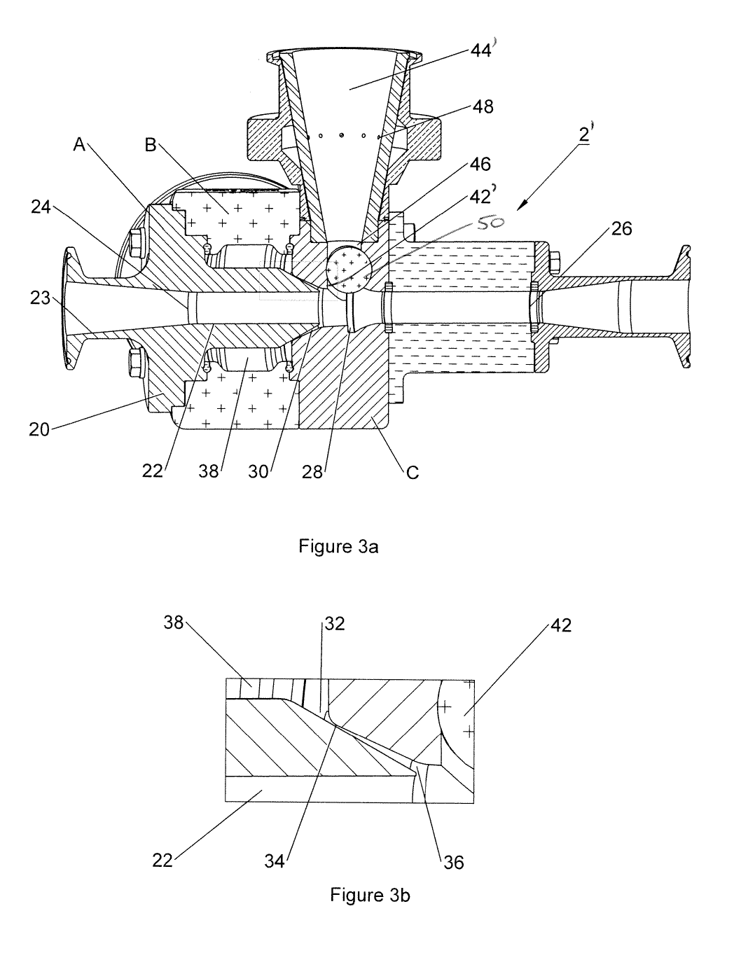

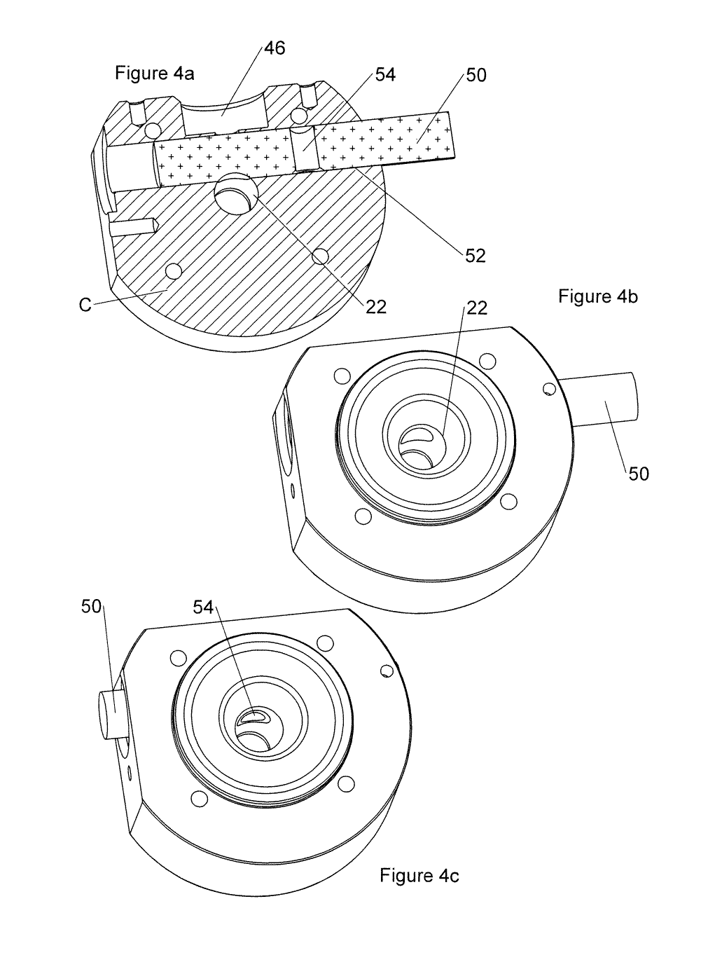

FIG. 3a shows a section through an alternative apparatus for use in the system of FIG. 1;

FIG. 3b shows a detail view of the nozzle of the apparatus shown in FIG. 3a;

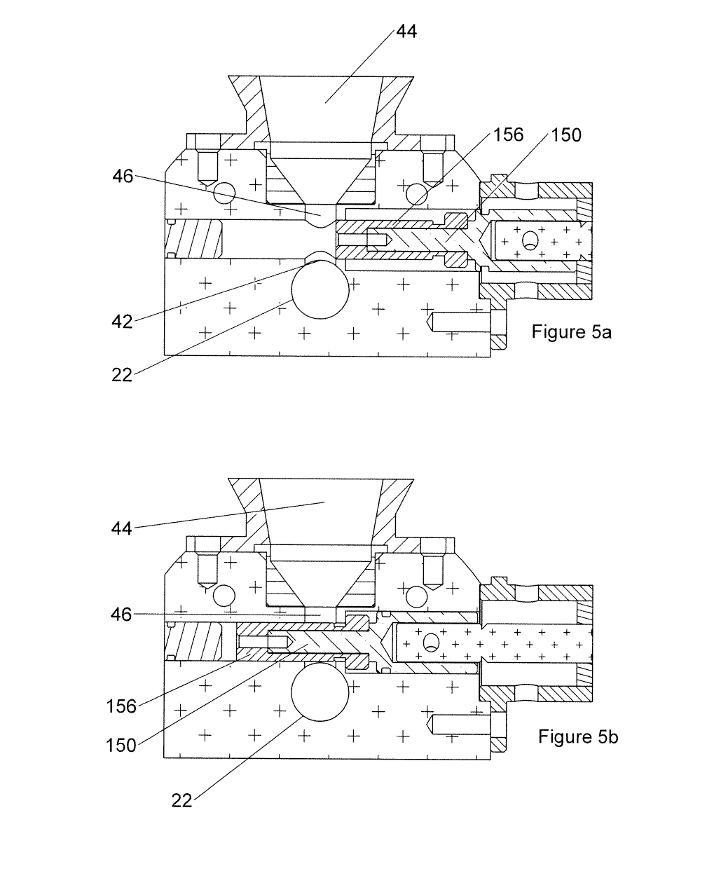

FIGS. 4a to 4c show a first embodiment of a piston valve arrangement used in the apparatus shown in FIG. 3a;

FIGS. 5a and 5b show section views of a second embodiment of a piston valve arrangement;

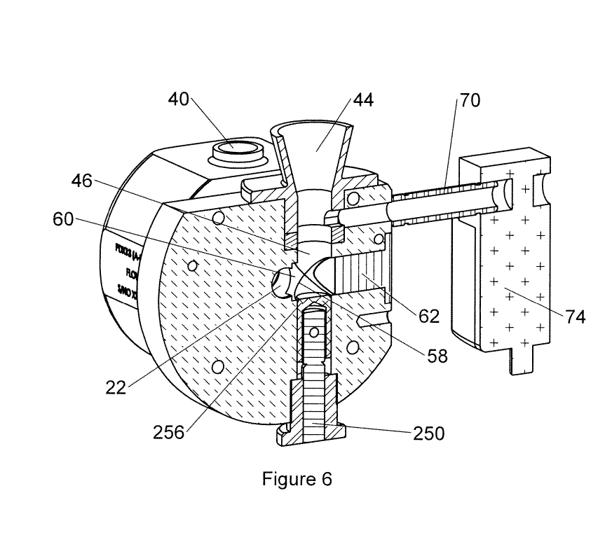

FIG. 6 shows a third embodiment of a piston valve arrangement;

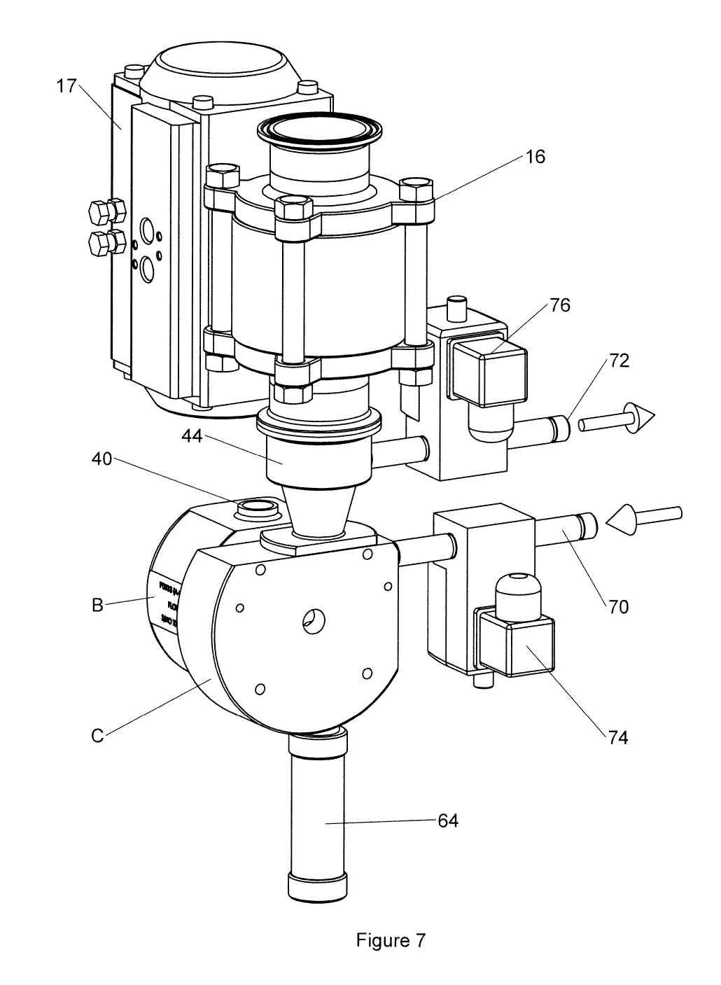

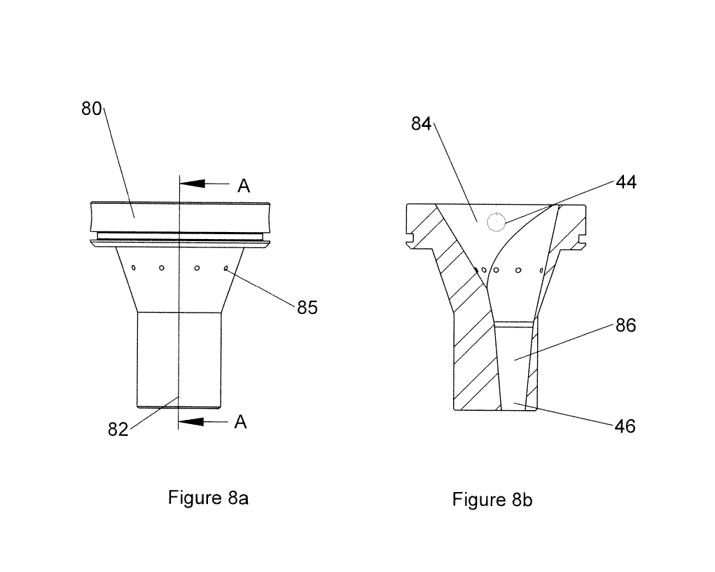

FIG. 7 shows the valve arrangement of FIG. 6 in the system of FIG. 1;

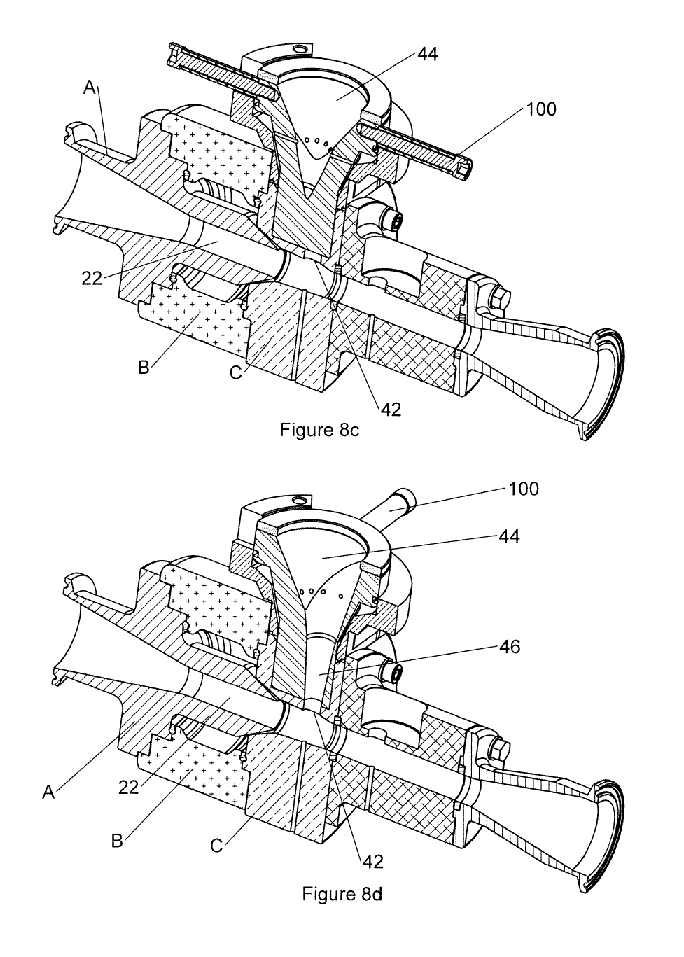

FIGS. 8a and 8b show a rotary valve member of an alternative rotary valve arrangement;

FIGS. 8c and 8d show the rotary valve member arranged on the apparatus in a closed and open position respectively;

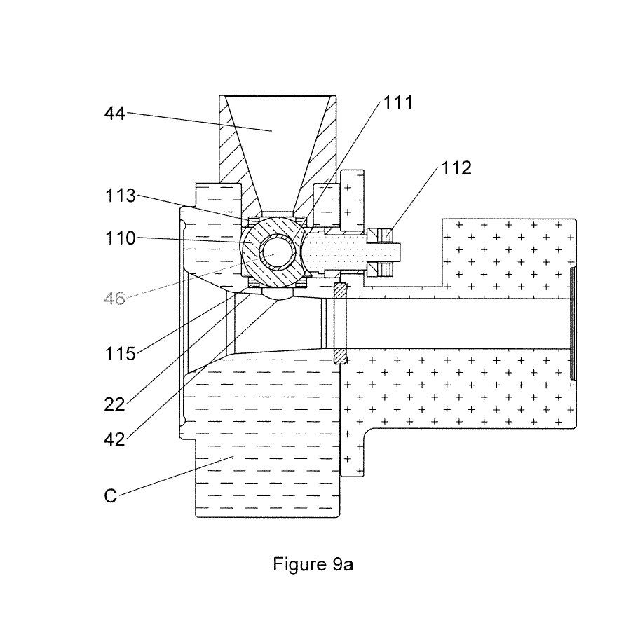

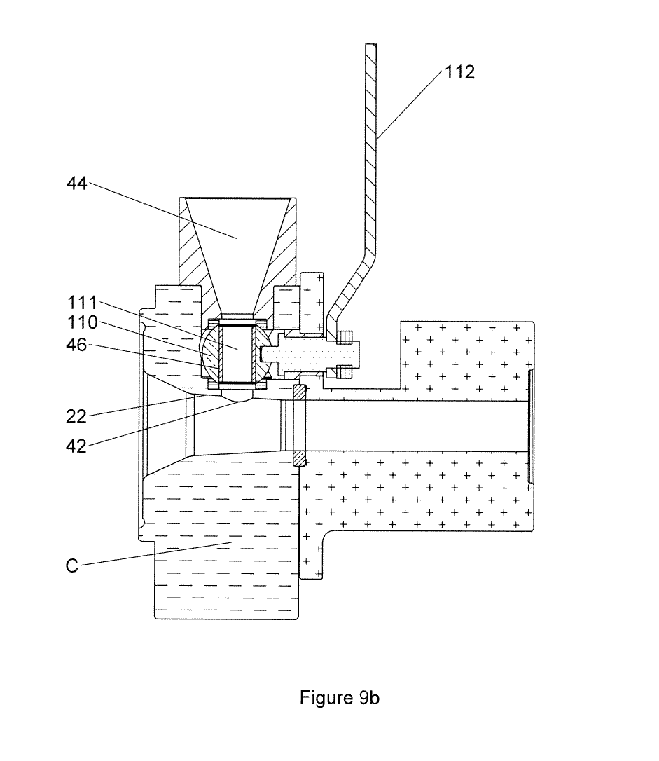

FIGS. 9a and 9b show an alternative ball valve arrangement arranged on the apparatus in a closed and open position respectively;

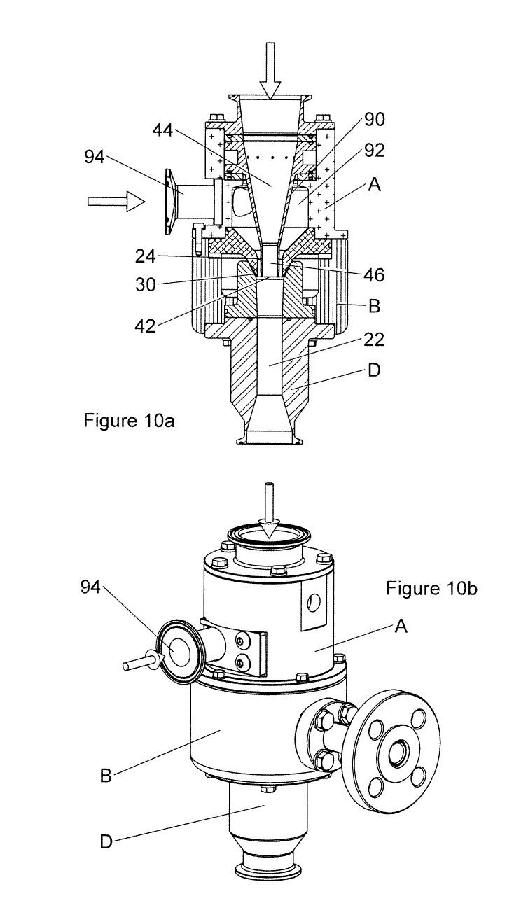

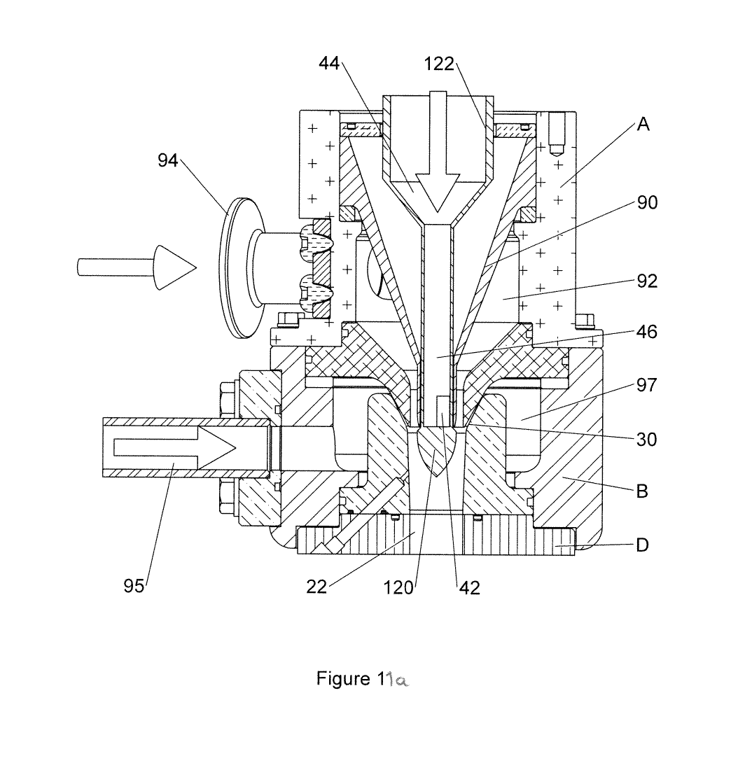

FIGS. 10a and 10b show a third embodiment of apparatus for use in the system of FIG. 1; and

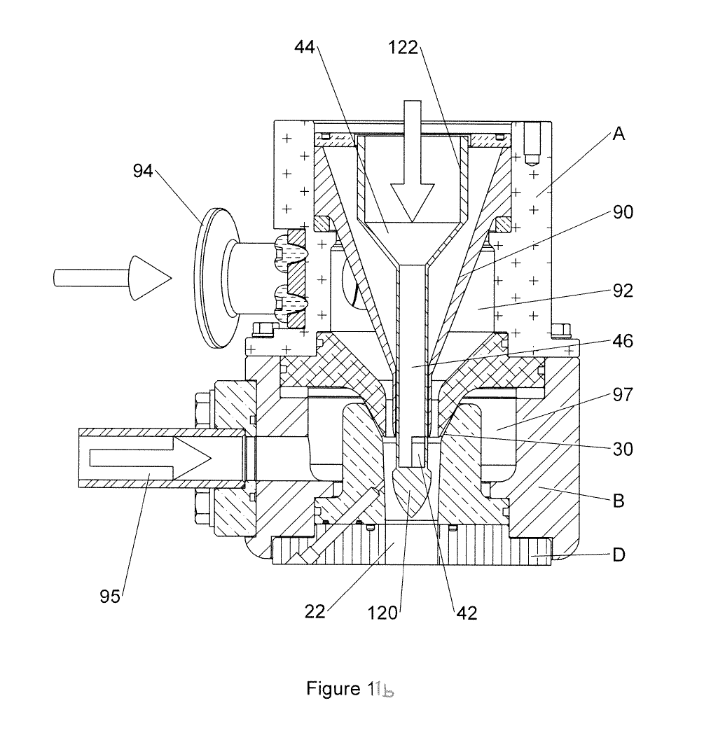

FIGS. 11a and 11b show a fourth embodiment of apparatus for use in the system of FIG. 1.

As shown in FIG. 1, a system 1 for entraining a powder in a process fluid includes a hopper 3 comprising a motor 4 which drives a stirrer 6. The hopper contains an amount of powder and the stirrer ensures the powder remains in a fluid state and does not become lumped together. Such powders may include non-state changing powders, e.g. silica, pigments, clays, sugars, milk powders, zeolites, which simply dissolve into the fluid once entrained and mixed, state changing powders, e.g. Carboxymethylcelluloses, Xanthan, Carbopol, Carragenan, Alginates, which gel and/or swell once in contact with water, and shear sensitive materials, e.g. dry encapsulated materials, fragrances and enzymes. An auger screw 8 and optional pump (not shown) move the powder from the hopper 3 through a powder supply conduit 12. The conduit 12 may include a pressure transducer 10 and a window 14 to view the flow of powder therethrough. A ball valve 16 selectively controls the flow of powder into a powder supply chamber 18 of a direct powder entrainment apparatus 2. An electronic control unit (ECU) 13 controls valves including the ball valve 16 and receives signals from the transducer 10 and at least two sensors 15,19 within the apparatus 2.

FIG. 2 shows the apparatus 2 in more detail. The apparatus has a body 20 in which a number of passages are defined. The body 20 and the passages therein may be formed from a single piece of material, but they are preferably formed from the interconnection of a number of separate components, as illustrated in FIG. 2. In the preferred embodiment shown, the body 20 is formed from three main components: a base member A, a collar member B located on the base member A, and a cap member C located on the collar member B. However, it should be understood that the present invention is not limited to this particular arrangement and assembly of components.

The body 20 has a fluid process passage 22 extending longitudinally through the body 20. In the illustrated embodiment the process passage 22 has an optional funnel 23 which tapers to an inlet 24, and an outlet 26 through which a process fluid flows. The flow of fluid entering the process passage 22 may be pumped and may be controlled by one or more control valves. The process passage has a first cross sectional area at the inlet 24 which remains constant before reaching a portion of the process passage 22 which has an increased cross sectional area defining a mixing chamber 28. The outlet 26 has the same cross sectional area as the inlet 24.

A nozzle 30 opens into the process passage 22 at a location between the passage inlet 24 and passage outlet 26. The nozzle 30 is an annular nozzle which lies radially outwards of the passage 22, and consequently circumscribes, or surrounds, the passage 22. The nozzle 30 has a nozzle inlet 32, a nozzle throat 34 and a nozzle outlet 36. The nozzle throat 34 has a cross sectional area which is less than the nozzle inlet 32 and nozzle outlet 36. The cross sectional area of the nozzle gradually increases from the nozzle throat 34 to the nozzle outlet 36. The nozzle inlet 32 is in fluid communication with an annular entrainment fluid chamber 38 located radially outward of the process passage 22. Consequently, the entrainment fluid chamber 38 surrounds both the nozzle 30 and the passage 22. The entrainment fluid chamber 38 is connectable to an entrainment fluid supply (not shown), such as for example a steam generator, by an entrainment fluid supply passage 40 which extends to the exterior of the body 20 in a direction generally perpendicular to the process passage 22. For the avoidance of doubt, references to “entrainment fluid” in this specification relate to a fluid which facilitates the entrainment of a powder in a process fluid, and not the fluid being entrained. The entrainment fluid is preferably steam injected into the process passage at high speed, preferably at speeds greater than Mach 1 although high subsonic speeds close to Mach 1 are also suitable. In some instances the flow velocity may be 900 m/s at the nozzle exit.

Also opening into the process passage 22 at a location downstream of and spaced from the nozzle outlet 36 is a first port 42. The first port 42 is a single aperture in the wall of the process passage and is sufficiently sized to allow a controlled amount of powder to flow therethrough without blocking. The first port 42 is in fluid communication with a powder supply chamber 44 located directly above the first port 42 by a powder supply passage 46 which extends to the exterior of the body 20 in a direction substantially perpendicular to the process passage 22. The angle of the powder supply passage 46 and/or nozzle relative to process passage 22 may be different to suit different applications/powders and powder entrainment/addition rates. The powder supply passage 46 is substantially straight and the first port 42, passage 46 and chamber 44 are coaxial to allow powder to flow along a direct path from the powder supply chamber 44 to the first port 42. Referring back to FIG. 1, the powder supply chamber 44 is connected to the hopper 3 by the powder supply conduit 12.

FIGS. 3a and 3b show views of a second embodiment of apparatus, designated 2′, which may be used with the system of FIG. 1. The majority of the components of the second embodiment of apparatus are shared with the first embodiment shown in FIG. 2, and thus share the same reference numbers and will not be described again in detail here. Where the second embodiment 2′ differs is that in this embodiment the first port 42′ has a cross sectional area which is at least half that of the process passage inlet 24 and outlet 26, and preferably is substantially identical to that of the inlet 24 and outlet 26. This embodiment is also provided with a piston valve to control powder flow through the port 42′, the piston valve having a piston valve member 50 as will be described in more detail with reference to FIG. 4.

A further distinction between the first and second embodiments of the apparatus is that a plurality of equally spaced apertures 48 are provided in the powder supply chamber 44′ in the second embodiment 2′, to which an air source is connectable.

Forcing air into the chamber 44′ provides an air curtain in the chamber 44′ to fluidise the powder in the chamber 44′ and to prevent clogging or blockages therein. The air introduced into the chamber 44′ will also urge powder therein to flow towards the first port 42′. FIG. 3b shows the nozzle 30, which is substantially identical to that used in the first embodiment of the apparatus 2, in more detail.

As shown in FIG. 4, the cap member C houses a piston valve arrangement having a piston valve member 50. The valve member 50 is slideably mounted in a valve bore 52 in the cap C to move between a closed position and an open position when driven by an actuator (not shown). The valve member 50 includes a lateral throughbore 54 to allow powder to flow through when the valve member 50 is in an open position, as shown in FIG. 4c. The lateral throughbore 54 may form at least part of the powder supply passage 46. The valve member 50 is complimentarily shaped with the process passage 22 to continue the internal surface of the passage 22 when the valve is at least in the closed position, as shown in FIGS. 4a and 4b. The powder supply passage 46 is arranged directly above the process passage 22 to be axially aligned on a vertical plane therewith. This provides a direct flow path for the powder to follow from the powder supply chamber 44 to the first port 42.

An alternative embodiment of the piston valve is shown in FIGS. 5a and 5b. The piston valve may include a valve head 156 threadably connected to an end of the valve member 150 and the piston head 156 may close the powder supply passage 46 when moved to a closed position and move away from the powder supply passage 46 into an open position to allow powder to flow to the first port 42, rather than aligning a throughbore of the valve member with the powder supply passage 46, as in the first embodiment shown in FIG. 4. Again, the powder supply passage 46 is arranged directly above the process passage 22 to be axially aligned on a vertical plane therewith to provide a direct flow path for the powder to follow from the powder supply chamber 44 to the first port 42.

A further alternative embodiment of the piston valve is shown in FIG. 6. The cap member C comprising the process passage 22 is attached to the collar portion B including the entrainment fluid supply passage 40. The cap member C has a valve throughbore 58 which is offset from the longitudinal axis of the process passage 22. A further bore 60 arranged perpendicularly to the valve throughbore 58 fluidly connects the throughbore 58 to the process passage 22. This further bore is blanked off by a threaded blank 62. An upper portion of the valve throughbore 58 defines the powder supply passage 46 which is connected to the powder supply chamber 44. A piston head 256 slideably moves between an open position and a closed position in the lower portion of the valve throughbore 58. The offset valve throughbore 58 allows for at least one further valve throughbore (not shown) to be provided in the cap member C to communicate with the process passage 22. A further valve throughbore may be provided on the opposite side of the process passage 22 to the valve throughbore 58 shown in FIG. 6 for example. The further valve throughbore would define a further powder supply passage connected to a corresponding powder supply chamber which may contain powder which is the same or different to that of the powder supply chamber 44. This allows powder from different chambers to be simultaneously or separately supplied to the process passage 22, whilst still providing a direct path for powder to flow.

FIG. 7 shows the piston valve embodiment of FIG. 6 in situ in the system of FIG. 1. The cap member C is attached to the collar member B by suitable fasteners such as tie rods (not shown). An actuator 64, such as a solenoid, selectively drives the piston valve slideably mounted in the cap member C. The powder supply chamber 44 is connected on top of the cap member C to the powder supply passage therein. The ball valve 16 is selectively driven by a motor 17 to control the movement of powder to the powder supply chamber 44. The cap member C further includes an air inlet passage 70 which extends outwardly from the cap member C in a perpendicular direction from the powder supply passage 46, as best shown in FIG. 6. An air source is connected to the air inlet passage 70 to force air into and through the powder supply passage 46 when the apparatus is not in use. An air outlet passage 72 is provided upstream of the powder supply chamber 44 as shown in FIG. 7 to ensure the air directed into the apparatus flows upwardly through the powder supply passage 46 to purge the same before or after an entrainment run.

This ensures any powder which has accumulated or lodged to the inside of the powder supply chamber 44 or passage 46 is blown and cleared therefrom and the same are kept as dry. Control valves and/or air pumps 74, 76 control/generate the air purging system.

Conveniently, a part of the apparatus may be easily replaced if required. For example, with reference to FIG. 6, the cap member C may be easily replaced if the piston valve 250 or powder supply passage 46 becomes damaged or worn. The powder supply chamber 44 may be easily replaced even when the apparatus is in use. In this case, the piston valve 250 would be closed whilst a second piston valve is opened, or remains open, to continue the flow of powder into the process passage 22. The damaged or worn powder supply chamber 44 may then be removed from the cap member C and replaced without having to shut down the apparatus.

An alternative to the piston valve arrangements may be a rotary valve arrangement, as shown in FIGS. 8a to 8d. The rotary valve comprises a valve body 80 rotatable about an axis 82 between open and closed positions by a suitable drive such as a motor. The valve body 80 is rotatably mounted to the cap member C of the apparatus and houses the powder supply chamber 44 and the powder supply passage 46. An upper portion 84 of the chamber 44 is concentric to the axis of rotation 82 whilst a lower portion 86 is offset from the axis 82. The powder supply passage 46 extends downwardly from the lower portion of the chamber 44 to communicate directly with the first port 42 of the process passage 22 (not shown). When in an open position, as shown in FIG. 8d, the powder supply passage 46 of the rotary valve 80 is aligned with the first port 42 to allow powder to flow into the process passage 22 for entrainment in the process fluid. When moved into a closed position, as shown in FIG. 8c, the powder supply passage 46 of the rotary valve 80 is also moved out of alignment with the first port 42 to thereby prevent powder entering the process passage 22. This arrangement provides a direct path for powder to flow from the chamber 44 to the first port 42 and also ensures the powder supply passage 46 and chamber 44 are kept dry, particularly before and after a process run, when the valve is closed. The rotary valve 80 may include a plurality of through apertures 85 in the chamber 44 to which an air source may connect to provide air to ensure the powder therein is kept fluidised during and after an entrainment process. In this embodiment, a controlled load on the sealing surface should allow a reliable operation for long periods of time. The rotary valve member may be automatically rotated by a suitable drive, such as electric, pneumatic or hydraulic, or may be manually operated by levers 100 as shown in the illustrated embodiment.

A further alternative embodiment to the piston and rotary valve arrangements may be a ball valve comprising a ball valve member 110 and a removable sleeve 111 provided in a throughbore of the valve member, as shown in FIGS. 9a and 9b. The valve member 110 may be rotatably mounted between upper and lower seats 113, 115 and moved between a closed position, as shown in FIG. 9a, and an open position, as shown in FIG. 9b, by a suitable drive or manually using one or more levers 112 coupled to the valve member as shown in the illustrated embodiment. This valve arrangement is designed to prevent any contact from the process fluid in the process passage 22 with the dry powder inside the powder supply passage 46 and powder supply chamber 44. If fluid from the process passage 22 leaks around the lower seat 115, the fluid is isolated from the powder supply chamber by the upper seat 113 and is also contained between the upper and lower seats. An outlet channel or orifice (not shown) may be provided in the cap C to allow for any fluid and/or debris contained between the upper and lower seats 113, 115 to be removed. Conveniently, the channel or orifice may extend through with the cap C to be provided axially with the valve throughbore when the valve member 110 is in the closed position. Such an arrangement would allow trapped fluid and/or debris and/or powder to be removed at the same time by, for example, blowing air therethrough. If some wetting of the removable sleeve occurs, it can also be replaced either manually or by mechanically dislodging the wet sleeve and inserting a clean and dry sleeve, preferably in the same operation. The wet sleeve may then be disposed of, or re-used after cleaning.

A third embodiment of the apparatus is shown in FIGS. 10a and 10b. A funnel member 90 houses the powder supply chamber 44, passage 46 and first port 42 upstream of the nozzle 30. The funnel member 90 is arranged inside the base member A of the apparatus which attaches to the entrainment collar member B. An end member D replaces the cap member C of the previously described embodiment shown in particularly FIGS. 2 and 3. The base member A surrounds the funnel member 90 to define a process fluid supply chamber 92 therebetween which is in fluid communication with the process fluid passage inlet 24. A process fluid supply passage 94 connected to a process fluid supply (not shown) communicates with the process fluid supply chamber 92 and extends generally perpendicularly from the body 2 of the apparatus relative to the process passage 22. Such a coaxial arrangement of the powder supply and process passage 22 further reduces the obstruction to powder flow. Depending on a particular application or powder properties, the location of the first port may be conveniently changed when desired to be upstream or downstream of the nozzle by varying the length of the powder supply passage 46 on the funnel 90.

A fourth embodiment of the apparatus is shown in FIGS. 11a and 11b. An inner funnel member 122 is slideably mounted in outer funnel member 90. The inner funnel 122 provides the powder supply chamber 44 and powder supply passage 46. A lower end of the inner funnel 122 distal from the powder supply chamber 44 comprises two or more slots to define the first port 42. A valve member 120 is provided at the lower end of the inner funnel 122 which, when in a closed position, as shown in FIG. 10c, sits in sealing engagement with the lower end of funnel member 90 thereby to prevent the flow of powder through the first port 42. When moved towards an open position, as shown in FIG. 10d, by suitable means, such as electromechanical or pneumatic, for example, the valve member 120 is moved downwardly and away from its seat (lower end of funnel member 90) to expose the slots of inner funnel member 122 to the process passage 22 to thereby allow powder to flow therein and be entrained into the process fluid. Valve member 120 is shaped to minimise its effect on the flow of process fluid in the process passage but could be any suitable shape to suitably seal the first port 42 when in a closed position. This arrangement may also include an air injection/purge arrangement to fluidise the powder in the powder supply chamber 44 and/or powder supply passage 46 of inner funnel member 122 or to clean out powder before or after a process operation. The entrainment fluid enters the apparatus via the entrainment fluid supply passage 95 which is connectable to an entrainment fluid supply (not shown). The entrainment fluid then flows into the entrainment fluid chamber 97 and hence into the nozzle 30.

Referring back to FIG. 1, each of the control valves and pumps provided in the system 1 is controlled by the ECU 13. The ECU 13 monitors the processing system by way of at least two sensors 15,19 located at selected points in the apparatus 2 and system. There are preferably multiple sensors monitoring flow rate, and/or pressure, and/or temperature of the process fluid, entrainment fluid and powder within the system. The sensor locations may include in the process passage 22 both upstream and downstream of the nozzle, in the entrainment fluid supply chamber 38 and/or passage 40, in the powder supply chamber 44 and/or passage 46, in the powder supply conduit 12, hopper 3 and/or air purge system 70, 72. Based on signals received from the sensors the ECU 13 can selectively adjust the control valves to vary the flow rates of the process fluid, entrainment fluid, powder and/or air.

The operation of the apparatus and processing system will now be described, with particular reference to FIGS. 1 and 3, although it should be understood that with the exception of the various powder dosing valve arrangements (where present) the system, apparatus and nozzle operate in substantially the same manner across all described embodiments. Initially, a process fluid is allowed to enter the process passage inlet 24 of the apparatus. The process fluid may be water, a sugar alcohol such as glycerol, a solvent such as ethanol, or a sugar syrup such as glucose or fructose syrup, for example. Alternatively, the process fluid may be an oil-in-water, a water-in-oil or an oil-in-water-in-oil emulsion, an aqueous or non-aqueous solution or suspension or dispersion of particles, or water containing one or more structuring components such as, for example, surfactants and/or thickening agents. The process fluid may be a slurry, such as a thickening agent in water.

When it is time for processing to commence a first control valve is opened by the ECU 13 in order to allow the process fluid to flow into the process passage 22. Where present, a pump is started to assist with the flow. A second control valve controlling the supply of entrainment fluid to the apparatus 1 is also opened by the ECU 13. Consequently, entrainment fluid flows from an entrainment fluid source into the entrainment fluid supply chamber 38 of the apparatus. In this preferred embodiment, the entrainment fluid is preferably steam and the entrainment fluid supply is preferably a steam generator. In any of the embodiments described herein steam may be replaced as the entrainment fluid with another compressible gas such as, for example, carbon dioxide or nitrogen.

Once the first and second control valves have been opened, the ball valve 16 and piston valve 50 (or rotary valve 80 or ball valve 110) will also be opened by the ECU 13 and the auger 8 driven in order to start the flow of powder from the hopper 3 to the powder supply chamber 44 and into the process passage 22 of the apparatus 1. If present, an optional pump is also activated to assist with the powder flow. The powder may be one of the following: non-state changing (e.g. silica, clays, sugars) or state changing powders, e.g. celluloses, gums or thickening agents.

The entrainment fluid and powder will arrive in their respective supply chambers 38, 44. The entrainment fluid is forced under pressure from the supply chamber 38 to the nozzle 30. The reduction and subsequent increase in cross sectional area through the nozzle 30 causes the entrainment fluid to accelerate through the nozzle 30 and a high velocity, preferably supersonic, jet of entrainment fluid is injected into the processing passage 22 from the nozzle outlet 36. ‘High velocity’ is to be understood to be in the range of from 100 m/s to 1000 m/s, and preferably approximately 900 m/s. At the same time, the process fluid is flowing through the process passage 22.

As the entrainment fluid is injected into the passage 22 from the nozzle 30 it imparts a shearing force on the process fluid as it passes the nozzle outlet 36. At the same time, a stream of the powder is entering the process passage 22 from the first port 42. The injected entrainment fluid imparts a shearing force and also generates a turbulent region in the mixing chamber 28. This combination of shear and turbulence leads to the at least partial atomisation of the process fluid. In other words, the injection of the entrainment fluid causes the process fluid to break down into very small particles and/or droplets and may cause some of the fluid present to evaporate. The differences in flow properties (e.g. velocity and pressure) between the entrainment fluid, powder and the process fluid also leads to a momentum transfer from the high velocity entrainment fluid to the lower velocity process fluid and powder, causing the process fluid and powder to accelerate.

Expansion of the entrainment fluid upon exiting the nozzle 30 causes an immediate pressure reduction in the mixing chamber 28 of the process passage 22. The injection of the entrainment fluid into the process fluid and powder creates dispersed phases of process fluid droplets and powder in a continuous vapour phase of entrainment fluid and possibly some of the process fluid. The powder is thus successfully entrained in the first process fluid.

As it moves towards the outlet 26 the fluid flow will begin to decelerate. This deceleration will result in an increase in pressure within the process passage 22. At a certain point between the mixing chamber 28 and the passage outlet 26, the decrease in velocity and rise in pressure will result in a rapid condensation of the vapour present in the passage 22. The point at which this rapid condensation begins defines a condensation shockwave within the passage 22. A rise in pressure and consequent vapour-to-liquid phase change takes place across the condensation shockwave, with the flow returning to the liquid phase on the downstream side of the shockwave. The powder is thus successfully drawn into and dispersed throughout the process fluid.

The position of the shockwave within the passage 22 is determined by the supply parameters (e.g. pressure, density, velocity, temperature) of the various fluids, the geometry of the apparatus 2, and the rate of heat and mass transfer between the entrainment and process fluids. Where steam is used as the entrainment fluid the dryness fraction of the steam can also effect the performance of the apparatus.

At the point of injection, the velocity of the entrainment fluid may be at least Mach 0.2 and is preferably within a range of from Mach 1.0 to Mach 2.5. Most preferably the entrainment fluid is injected at a supersonic speed of from Mach 1.5 to Mach 2.2.

In one test example using the apparatus shown in FIGS. 1 and 2, the process fluid was supplied to the process passage at a flow rate of 38 litres per minute, with the pressure in the process passage upstream of the nozzle being −0.5 Barg and the pressure downstream of the nozzle being 0.5 Barg. In the test, the entrainment fluid was steam and was delivered to the nozzle at 7.5 Barg.

No prolonged mechanical shear is imparted to the process flow in the process passage 22, thereby reducing wear of the apparatus. Furthermore, in contrast to known processing methods where damage to high value and shear sensitive materials can result due to the long residence times and mechanical shear the materials are exposed to, smaller quantities of these materials are required which translates into cost savings and possible health benefits. A suitable material for the apparatus may be stainless steel or brass or, at least in the vicinity of the nozzle where temperatures are highest, Polyether ether ketone (PEEK), a high temperature plastics material.

Once the entrained powder and process fluid leave the passage outlet 26, they are passed to either the storage vessel or else a further processing step downstream of the apparatus. A further processing step may be further entrainment of an identical powder in the combined powder and fluid to provide a series of entrainment processes for entraining a single powder into a fluid. Alternatively, two or more different powders may be entrained simultaneously or separately in a process fluid.

Further alternatively, two or more apparatus may be arranged in parallel or series with one another to entrain one or more different powders into a process fluid. A combination of series and parallel arrangements may also be provided.

Modifications and improvements may be incorporated without departing from the scope of the present invention.

1. An apparatus for entraining a powder in a process fluid, comprising:
a process passage having a passage inlet connectable to a source of process fluid, and a passage outlet;
a nozzle opening into the process passage intermediate the passage inlet and passage outlet, the nozzle having a nozzle inlet, a nozzle outlet and a nozzle throat intermediate the nozzle inlet and nozzle outlet, wherein the nozzle throat has a cross sectional area which is less than that of the nozzle inlet and nozzle outlet; at least one first port opening into the process passage adjacent the nozzle outlet;
an entrainment fluid supply chamber in fluid communication with the nozzle; and
a first powder supply chamber connected to the first port by a first powder supply passage, wherein the powder supply chamber, powder supply passage and first port are coaxial.

2. The apparatus of claim 1, wherein the powder supply passage has a constant cross sectional area along its length.

3. The apparatus of claim 1, wherein the first port has a cross sectional area which is at least half the cross sectional area of the process passage at the point where the first port opens into the process passage.

4. The apparatus of claim 1, wherein the first port has a cross sectional area which is the substantially identical to the cross sectional area of the process passage at the point where the first port opens into the process passage.

5. The apparatus of claim 1, wherein the cross sectional area of the first port and powder supply passage are substantially identical.

6. The apparatus of claim 1, wherein the powder supply chamber and/or powder supply passage have internal surfaces which are polished and/or formed from one or more low friction materials.

7. The apparatus of claim 1, wherein the axis of the powder supply chamber, powder supply passage and first port is substantially perpendicular to a longitudinal axis of the process passage.

8. The apparatus of claim 1, wherein the first port is located downstream of the nozzle in the process passage.

9. The apparatus of claim 1, wherein the process passage is substantially vertical, the powder supply chamber, powder supply passage and first port are coaxial with the process passage, and wherein the first powder supply passage and first port extend a distance into the process passage from the process passage inlet.

10. The apparatus of claim 1 further comprising a gas chamber connected to a gas supply, and a wall of the powder supply chamber includes a plurality of apertures which permit gas to flow into the powder supply chamber from the gas chamber.

11. The apparatus of claim 10, wherein each aperture extends in a radial or tangential direction relative to a longitudinal axis of the powder supply chamber.

12. The apparatus of claim 10, wherein each aperture has an internal taper which reduces or increases the cross sectional area through the respective aperture.

13. The apparatus of claim 1 further comprising a first valve located within the powder supply passage proximal the first port to selectively open and close the first port.

14. The apparatus of claim 13, wherein the first valve also regulates the flow of powder from the powder supply passage into the process passage.

15. The apparatus of claim 13, wherein the first valve comprises an elongate valve member slideably mounted in a valve body, and an actuator for selectively driving the valve member between open and closed valve positions.

16. The apparatus of claim 15, wherein the valve body includes a through aperture which forms part of the process passage between the passage inlet and passage outlet.

17. The apparatus of claim 15, wherein the valve member includes the first port and the powder supply passage.

18. The apparatus of claim 15, wherein the valve member forms part of a continuous internal surface of the process passage when in the closed position.

19. The apparatus of claim 13, wherein the first valve is a rotary valve comprising a rotary valve member having a longitudinal throughbore to define at least part of the powder supply passage, the throughbore being offset from an axis of rotation of the rotary valve member such that selective rotation of the valve member brings the throughbore into or out of alignment with the first port to open and close the valve.

20. The apparatus of claim 13, wherein the first valve is a ball valve having a valve body which includes a central throughbore defining at least part of the powder supply passage, and wherein rotation of the valve body about an axis of rotation brings the throughbore into or out of alignment with the first port to open and close the valve.

21. The apparatus of claim 20, wherein an exterior surface of the ball valve body member forms part of an internal surface of the process passage when in a closed position.

22. The apparatus of claim 1, wherein the process passage inlet has a first cross sectional area, and the cross sectional area of the process passage does not reduce below the first cross sectional area at any point between the passage inlet and passage outlet.

23. The apparatus of claim 22, wherein a portion of the process passage has a second cross sectional area which is greater than the first cross sectional area and defines a mixing chamber in the process passage, and wherein at least a downstream portion of the first port opens into the mixing chamber.

24. The apparatus of claim 1, further comprising:
a compressed air source;
a catch vessel;
an air inlet passage connecting the air source to the powder supply passage; and
an air outlet passage connecting the powder supply chamber to the catch vessel, wherein compressed air can be selectively forced through the air inlet and outlet passages to purge powder from the powder supply chamber and powder supply passage into the catch vessel.

25. A system for entraining a powder in a process fluid, the system comprising: an apparatus in accordance with claim 1;
a process fluid supply vessel in fluid communication with the process passage inlet;
an entrainment fluid supply in fluid communication with the entrainment fluid supply chamber;
a first powder supply vessel in communication with the first powder supply chamber;
a plurality of control valves for controlling the supply of process fluid, entrainment fluid and powder to the apparatus;
a plurality of sensors located in at least the process passage of the apparatus; and
an electronic control unit adapted to selectively open and close the control valves in response to signals from the plurality of sensors.

26. A method of entraining a powder in a process fluid, the method comprising: supplying a process fluid to a process passage having a passage inlet and a passage outlet;
supplying an entrainment fluid to a nozzle which opens into the process passage intermediate the passage inlet and passage outlet, the nozzle having a nozzle inlet, a nozzle outlet and a nozzle throat intermediate the nozzle inlet and nozzle outlet, wherein the nozzle throat has a cross sectional area which is less than that of the nozzle inlet and nozzle outlet;
supplying a powder from a first powder supply chamber via a first powder supply passage to a first port opening into the process passage adjacent the nozzle outlet, wherein the powder supply chamber, powder supply passage and first port are coaxial;
accelerating the entrainment fluid through the nozzle throat; and
injecting the entrainment fluid from the nozzle outlet into the process fluid and powder within the process passage.

27. The method of claim 26, further comprising the step of injecting a gas into the powder within the first powder supply chamber in order to fluidise the powder.

28. The apparatus of claim 2, wherein the powder supply passage is circular in cross section and has a uniform diameter along its length.
